(19) United States
(12) Patent Application Publication
(10) Pub. No.: US 2026/0071711 A1
(43) Pub. Date: Mar. 12, 2026

(54) Non-welded Pipe Bung System

(71) Applicant: Joshua Adam Smith, Durant, OK (US)

(72) Inventor: Joshua Adam Smith, Durant, OK (US)

(21) Appl. No.: 18/883,876

(22) Filed: Sep. 12, 2024

(51) Int. Cl. F16L 41/14; F16L 41/00

(52) U.S. Cl. CPC F16L 41/14; F16L 41/008

(57) ABSTRACT

The non-welded bung system is an apparatus which provides access through a wall to which the non-welded bung is installed. The non-welded bung system includes a flange and two or more fasteners. The flange has at least one bung aperture and two or more holes. The holes can receive hardware thereby allowing the flange to be attached to a wall. In some versions of the non-welded bung system the outer surface of the flange is curved to match the inside wall of a pipe. Unlike existing products, this system does not require that the bung is welded to the wall or pipe. When the non-welded bung system is installed on a pipe, a user may couple an article of instrumentation to the bung aperture without compromising the seal of the pipe. In some versions the seal between the flange and the wall may be improved with a gasket or silicone.

### BACKGROUND

### Field of the Invention

This disclosure relates to a bung fitting; more particularly, a bung fitting that may be joined to a surface without welding the bung fitting to the surface.

### Description of the Related Art

Welded bungs are commonly used when a user wishes to install a bung through a surface. A bung is an aperture through which the inside of a vessel or pipe may be accessed. In some applications, the user may weld a threaded bung into a pipe wall, such that a threaded fitting may be coupled to the welded threaded bung.

The prior art appears to be lacking a type of bung fitting that may be coupled to a surface, especially a curved surface, without needing to weld the fitting.

### SUMMARY

The disclosure concerns a type of bung system, referred to as a “non-welded bung system” or simply “the bung” herein. When installed, the bung provides access through the wall to which the bung is installed. For example and without limitation, if a user wishes to install a temperature sensor in a pipeline directly that measures the temperature of the fluid within the pipe, the user may install the non-welded bung system to the pipeline and then install their own temperature sensor through the bung into the pipeline's interior space.

The non-welded bung system comprises a flange and two or more fasteners. The flange is a panel-shaped object with one bung aperture and a two or more of flange holes. In the preferred embodiment, the outer surface of the flange is curved. The curved outer surface of the flange is intended to create a better seal between the flange and the object it is attached to.

In preferred embodiments, the bung is designed to be mounted to a cylindrical pipe or tube. To attach the bung to a pipe, the user may first drill a set of holes in the pipe which spatially match with the pattern of the bung hole and flange holes. Then the user would position the flange against the inside wall of the pipe, making sure that the curved surface of the flange matches and aligns with the inside wall of the pipe. The user would align the flange holes with the fastener holes in the pipe. The user may then secure the flange to the pipe by inserting bolt fasteners from outside the pipe, through the pipe wall, and into the threaded flange holes on the flange. The bolts may then be tightened into the threaded flange holes thereby securing the bung to the pipe.

### BRIEF DESCRIPTION OF THE DRAWINGS

Other features, combinations, and embodiments will be appreciated by one having the ordinary level of skill in the art of bung fitting and accessories upon a thorough review of the following details and descriptions, particularly when reviewed in conjunction with the drawings, wherein:

FIG. 1 shows a top perspective view of the flange in accordance with a first illustrated embodiment;

FIG. 2 shows a bottom perspective view of the flange in accordance with a first illustrated embodiment;

FIG. 3 shows a top view of the flange in accordance with a first illustrated embodiment;

FIG. 4 shows a top view of the flange in accordance with a first illustrated embodiment;

FIG. 5 shows a top view of the flange in accordance with a second illustrated embodiment;

FIG. 6 shows a top view of the flange in accordance with a third illustrated embodiment;

FIG. 7 shows a front sectional view of the flange in accordance with a first illustrated embodiment;

FIG. 8 shows a side sectional view of the flange in accordance with a first illustrated embodiment;

FIG. 9 shows a front profile view of the flange in accordance with a first illustrated embodiment;

FIG. 10 shows a side profile view of the flange in accordance with a first illustrated embodiment; and

FIG. 11 shows a non-welded bung system in accordance with a first illustrated embodiment.

FIG. 12 shows a pipe to which a non-welded bung system may be coupled.

FIG. 13 shows a non-welded bung system coupled to a pipe in accordance with a first illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

For purposes herein, the term “coupled” means that the coupled components, articles, or systems are separable from each other.

The term “attached” means that the attached components, articles, or systems are not separable from each other.

The term “integrated” means that the integrated components, articles, or systems refer to features which together form a continuous body.

The term “joined” means “coupled,” “attached,” “integrated,” or some combination thereof.

The term “fluid” means a liquid, a gas, or some combination thereof.

Unless explicitly defined herein, terms are to be construed in accordance with the plain and ordinary meaning as would be appreciated by one having skill in the art.

### General Description of Embodiments

The non-welded bung system comprises a flange and two or more fasteners. The flange is a panel-shaped object having an outer surface, an inner surface and a plurality of side surfaces which span the outer and inner surfaces. In preferred embodiments, the outer surface of the flange is curved. In some embodiments, the outer surface of the flange may be curved to substantially match the inside wall of a section of a cylinder. In some embodiments, the outer surface may be curved to substantially match the inside wall of a section of a curved cylinder, for example and without limitation, a section of a pipe elbow.

The flange has at least one bung aperture which passes between a flange outer surface and a flange inner surface. The flange also has flange holes around the bung aperture. In some embodiments, the flange holes pass between the flange outer surface and the flange inner surface. In some embodiments, the flange holes penetrate into the flange outer surface but do not pass through the flange inner surface.

In preferred embodiments, the bung aperture may be threaded such that a threaded fitting or article of instrumentation may be screwed into the bung aperture. The bung aperture may have a chamfer around its circumference on the flange outer surface. In some embodiments the bung aperture threads may be ⅜″-18 NPT.

In preferred embodiments, the flange holes may be threaded such that bolt fasteners may be screwed into the flange holes. In some embodiments, the flange hole threads may be M6 threads. In other embodiments, the flange holes may not be threaded. For some embodiments with non-threaded flange holes, a user may couple the flange to the pipe with rivets.

The flange further comprises a plurality of flange side surfaces which span the distance between the flange inner surface and the flange outer surface. In some embodiments, one or more of the flange side surfaces may form a fluid dynamic surface. A fluid dynamic surface is a surface that is shaped to reduce the frictional losses experienced by the fluid flowing through the pipe caused by the presence of the flange.

In preferred embodiments, the extremities of the fluid dynamic surfaces may be tapered towards the pipe inside wall. The more central sections of the fluid dynamic surface may rise away from the pipe inside wall to accommodate the depth of the bung aperture. Fluid dynamic surfaces may be formed by side surfaces which face upstream against the flow of fluid through the pipe, side surfaces which face downstream with the flow of fluid, side surfaces which face partly upstream or partly downstream and partly laterally with respect to the flow of fluid through the pipe, or some combination thereof. In some embodiments, a fluid dynamic side surface may be oriented at an angle with respect to the direction of fluid flow. In some embodiments, a fluid dynamic side surface may be curved, presenting a spectrum of tangential angles with respect to the direction of fluid flow.

In some embodiments, the most distal portion of a side surface may be oriented perpendicularly to fluid flow. In such embodiments the fluid dynamic surface may begin from perpendicular section of the side surface and continue towards the flange inner surface. In some embodiments, one or more side surfaces and a flange inside surface may form a continuous curved surface.

In some embodiments, a fluid dynamic surface may comprise multiple flat surfaces, referred to herein in as “FD planes.” In some embodiments, a fluid dynamic surface may comprise two FD planes. In some embodiments, a fluid dynamic surface may comprise three FD planes.

In preferred embodiments, the FD plane(s) that are closer to the flange outer surface have steeper taper, meaning a wider angle away from the pipe longitudinal axis. In preferred embodiments, the FD plane(s) which are further from the pipe wall have a less steep taper, meaning a narrower angle away from the pipe longitudinal axis.

In some embodiments, a sealant may be applied between the flange outer surface and the pipe inside wall. The sealant may be applied to improve the quality of the seal between the flange and the pipe. For example and without limitation the sealant may be a gasket or silicone.

### Manufacturing

The fasteners can be obtained commercially. Alternatively, the fasteners can be customized in accordance with the level and knowledge of one having skill in the art

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

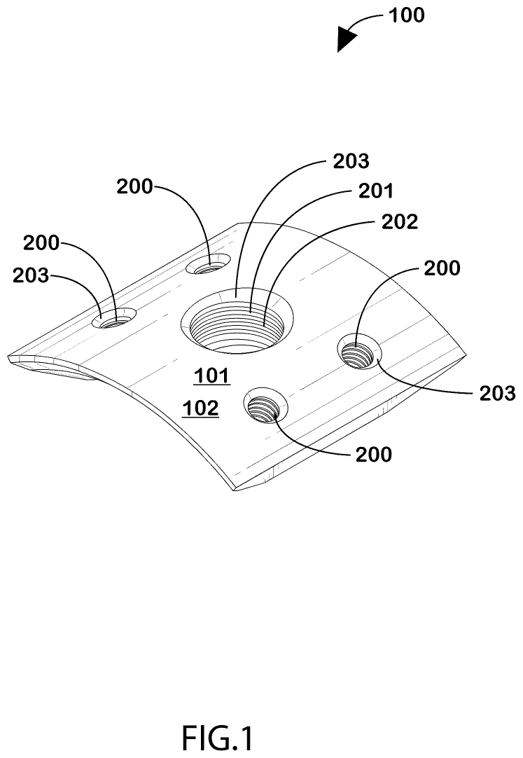

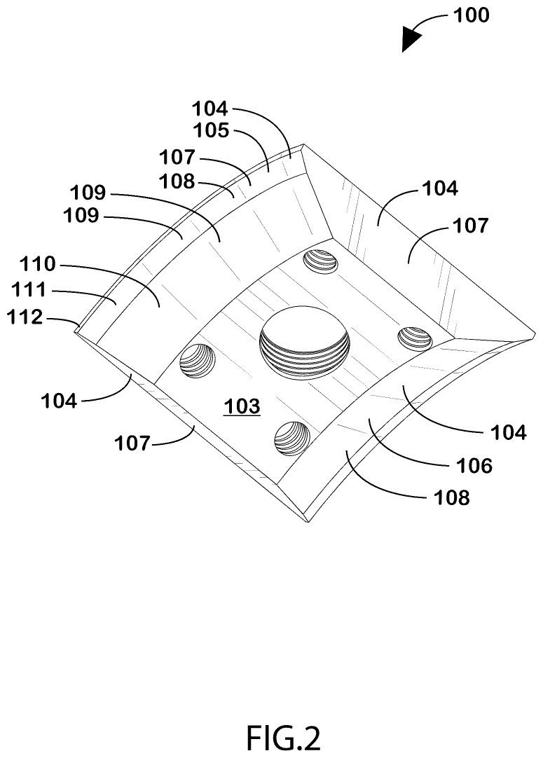

Now turning to the drawings, FIG. 1 and FIG. 2 show a flange (100) in accordance with a first embodiment. The flange is configured with a bung aperture (201), which in this embodiment is a threaded bung aperture (202). The flange is also configured with four threaded flange holes (200). Both the bung aperture and the flange holes are configured with a chamfer (203). In this embodiment the bung aperture and the flange holes pass between the flange outer surface (101) and the flange inner surface (103). The flange outer surface in this embodiment is a curved outer surface (102) which is shaped to conform to the inside wall of a pipe (400).

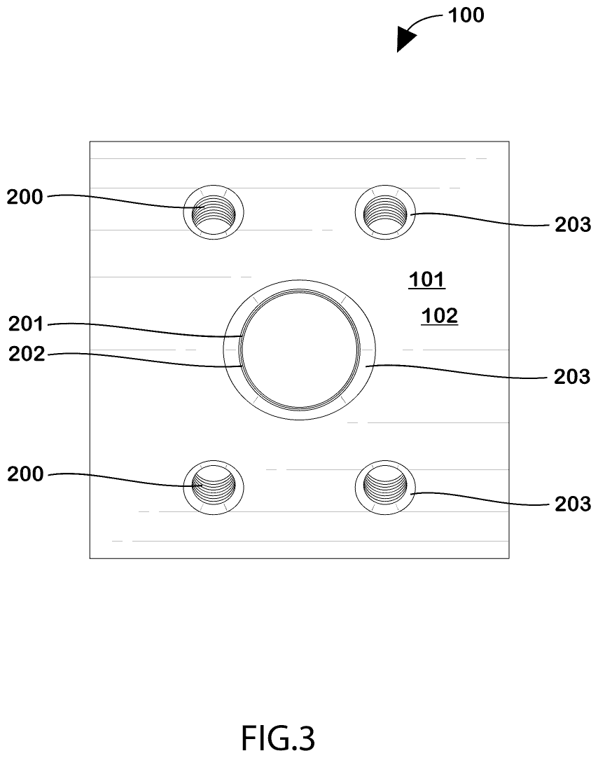

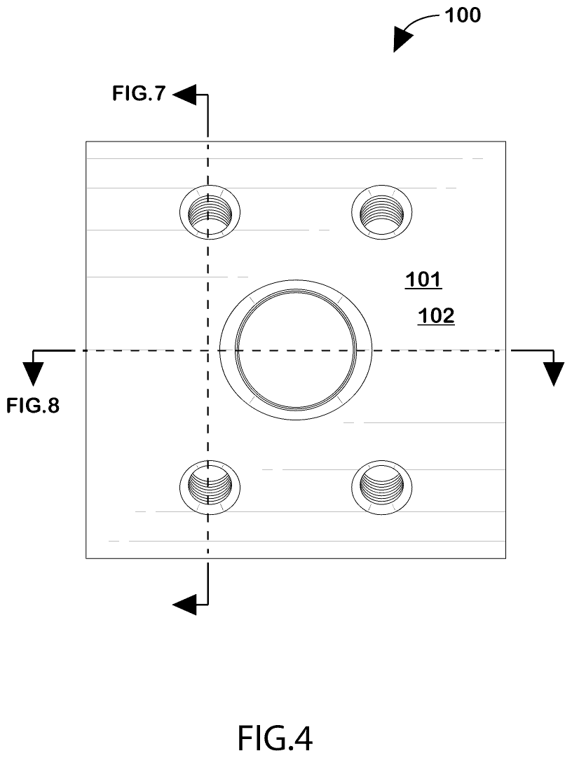

FIG. 3 and FIG. 4 show top plan views of a flange (100) in accordance with a first illustrated embodiment.

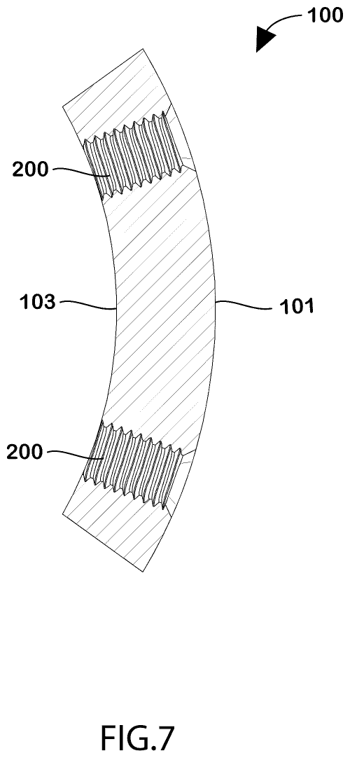

FIG. 7 shows a front sectional view of the flange (100) in accordance with a first illustrated embodiment. The threaded flange holes (200) are shown passing between the flange outer surface (101) and the flange inner surface (103). Other embodiments where the, flange holes do not pass through the flange inner surface are contemplated. In other embodiments, the flange holes may not be threaded.

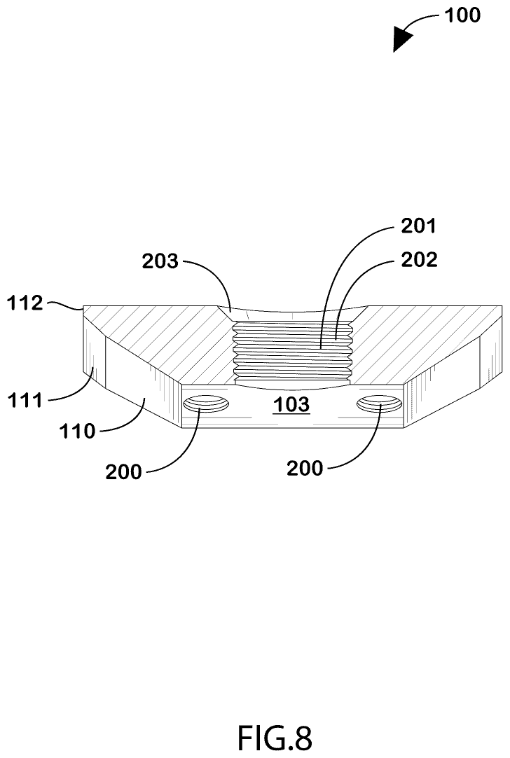

FIG. 8 shows a side sectional view of the flange (100) in accordance with a first illustrated embodiment. The threaded bung aperture (202) is shown passing between the flange outer surface (101) and the flange inner surface (103).

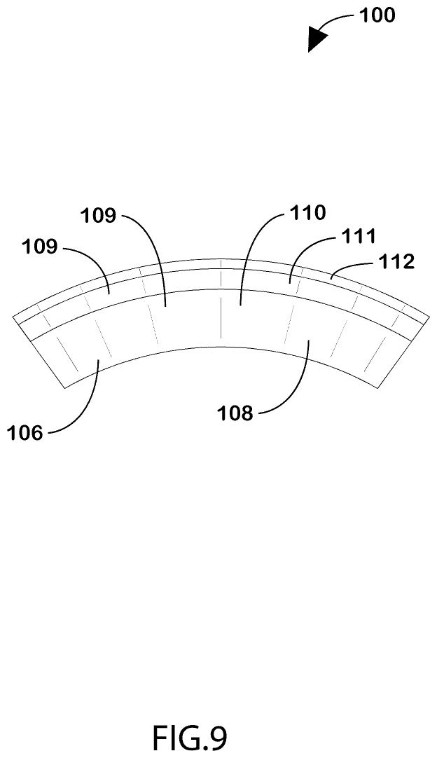

FIG. 9 shows a profile view of the flange (100) depicting the flange side surface (104), more specifically the back side surface (106). In the first embodiment, the back side surface and the front side surface have the same shape. They each form fluid dynamic surfaces (108) which are shaped to reduce the frictional losses experienced by a fluid flowing past the flange. The fluid dynamic surface shown in FIG. 9 is comprised of two fluid dynamic planes, or FD planes (109). FD plane 1 (110) and FD plane 2 (111) are both conical planes, each having a different conical angle. Plane 3 (112) is not considered an FD plane because the face of the plane is completely perpendicular with the flow of fluid.

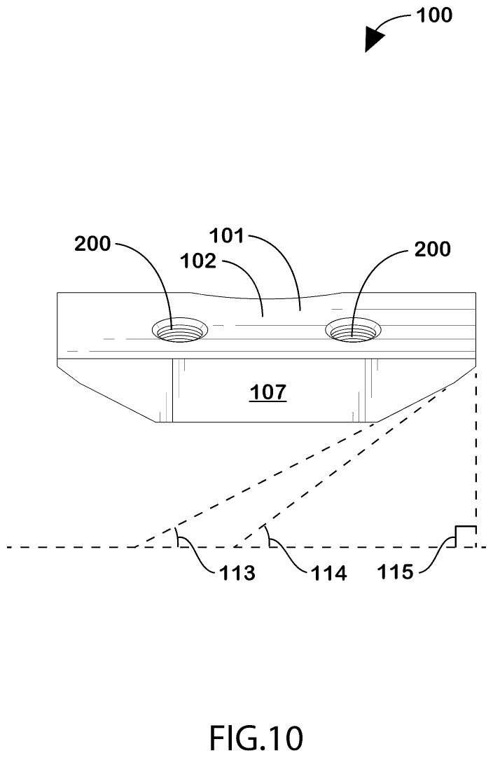

FIG. 10 shows a side profile view of the flange. A lateral side surface (107) is depicted as well as the curved outer surface (102) of the flange. The angles of plane 3 (112) and the FD planes (109) are also depicted. In this first embodiment, the angle of plane 3, identified as angle 1 (115), is 90 degrees with respect to the idealized flow direction of the fluid. The angle of FD plane which is further towards the outer extremity of the flange is a larger angle than the FD plane which is closer to the center of the flange. This is to say that angle 2 (114) is greater than angle 3 (113). In this first embodiment, angle 2 is 42.5 degrees, and angle 3 is 32.5 degrees.

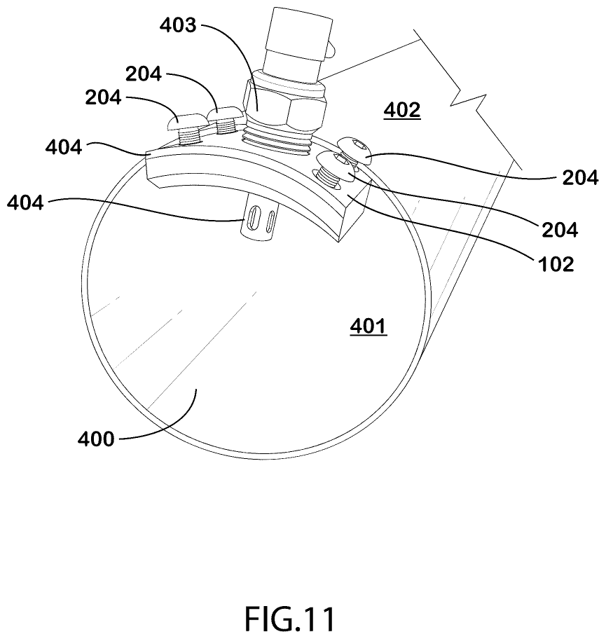

FIG. 11 shows a first illustrated embodiment of a non-welded bung system as it would be installed on a cutaway pipe (400) segment. The curved outer surface (102) is shaped to substantially conform with the pipe inside wall (401). In this depiction the pipe segment is straight, but curved outer flange surfaces which substantially conform to a curved segment of pipe, such as a pipe elbow, are contemplated. This figure also shows fasteners (204) which would couple the flange (100) to the pipe.

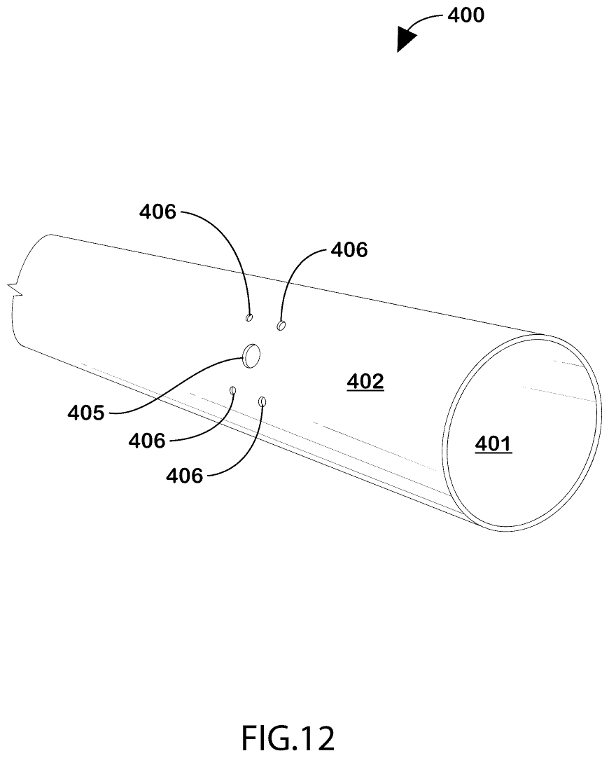

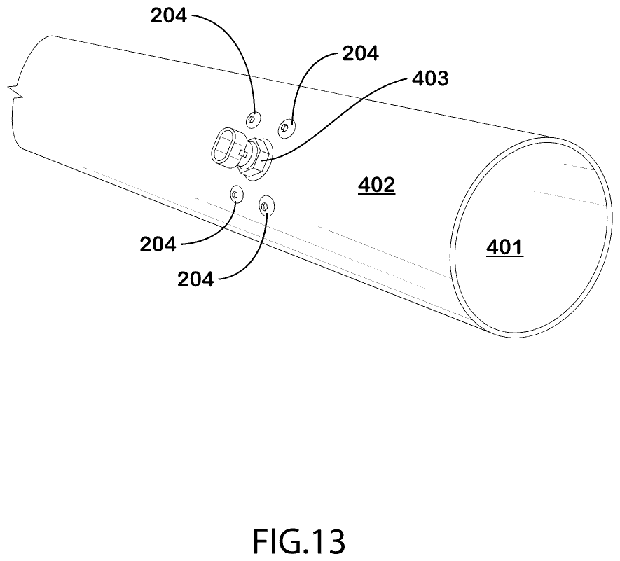

FIG. 12 shows a pipe (400) segment which has been prepared with four fastener holes (406) and one pipe bung hole (405). FIG. 13 shows the same pipe segment with a non-welded bung system installed. The fasteners (204), in this embodiment threaded bolts, secure the flange (100) to the pipe. A fitting (403) installed through the threaded bung aperture (202) is also depicted.

### Second Illustrated Embodiment

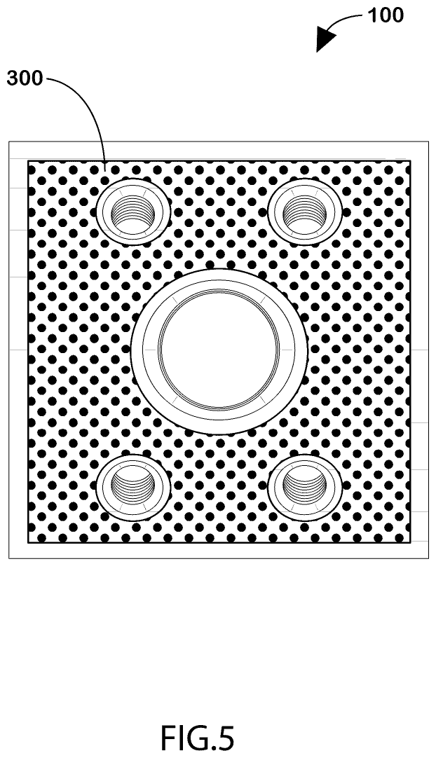

FIG. 5 shows a top plan view of a flange (100) in accordance with a second illustrated embodiment. The second illustrated embodiment is configured with a gasket (300). When the non-welded bung system is installed on a pipe (400) the gasket is compressed between the flange outer surface (101) and the pipe inside wall (401) thereby improving the quality of the seal between flange and the pipe.

### Third Illustrated Embodiment

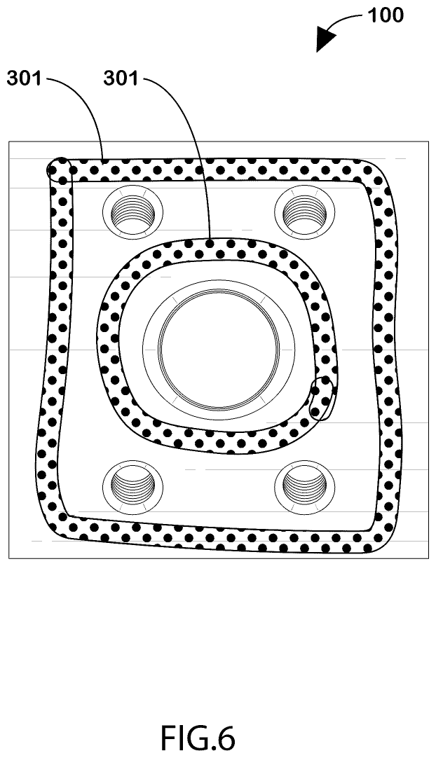

FIG. 6 shows a top plan view of a flange (100) in accordance with a third illustrated embodiment. The third illustrated embodiment is configured with silicone (300). When the non-welded bung system is installed on a pipe (400) the silicon is compressed between the flange outer surface (101) and the pipe inside wall (401) thereby improving the quality of the seal between flange and the pipe.

### FEATURE LIST

| | |
|---|---|
| Flange | (100) |
| Flange Outer Surface | (101) |
| Curved Outer Surface | (102) |
| Flange Inner Surface | (103) |
| Flange Side Surface | (104) |
| Front Side Surface | (105) |
| Back Side Surface | (106) |
| Lateral Side Surface | (107) |
| Fluid Dynamic Surface | (108) |
| FD Plane | (109) |
| FD Plane 1 | (110) |
| FD Plane 2 | (111) |
| Plane 3 | (112) |
| Angle 1 | (113) |
| Angle 2 | (114) |
| Angle 3 | (115) |
| Threaded Flange Hole | (200) |
| Bung Aperture | (201) |
| Threaded Bung Aperture | (202) |
| Chamfer | (203) |
| Fastener | (204) |
| Gasket | (300) |
| Silicon | (301) |
| Pipe | (400) |
| Pipe Inside Wall | (401) |
| Pipe Outside Wall | (402) |
| Fitting | (403) |
| Instrumentation | (404) |
| Pipe Bung Hole | (405) |
| Fastener Hole | (406) |

What is claimed is:

1. A non-welded bung system, comprising:
a. A flange; the flange having two opposing sides, a flange outer surface and a flange inner surface; the flange outer surface forming a curved outer surface which substantially conforms to the shape of an inside wall of a pipe, the flange further comprising a plurality of flange side surfaces which span the distance between the flange inner surface and the flange outer surface, the flange having two or more threaded flange holes into the flange outer surface, the flange having a bung aperture between the flange outer surface and the flange inner surface, the bung aperture having a section of threads to form a threaded bung hole,
b. Two or more fasteners; the fasteners being bolts adapted to thread into the threaded holes.

2. The non-welded bung system of claim 1, wherein:
a. One or more of the flange side surfaces is a fluid dynamic surface.

3. The non-welded bung system of claim 2, wherein:
a. A front side surface is a fluid dynamic surface.

4. The non-welded bung system of claim 3, wherein:
a. The fluid dynamic surface of the front side surface comprises three FD planes.

5. The non-welded bung system of claim 2, wherein:
a. A back side surface is a fluid dynamic surface.

6. The non-welded bung system of claim 5, wherein:
a. The fluid dynamic surface of the back side surface comprises three FD planes.

7. The non-welded bung system of claim 2, wherein:
a. A front side surface is a fluid dynamic surface, and a back side surface is a fluid dynamic surface.

8. The non-welded bung system of claim 7, wherein:
a. The fluid dynamic surface of the back side surface comprises three FD planes, and the fluid dynamic surface of the back side surface comprises three FD planes.

9. The non-welded bung system of claim 1, wherein:
a. The flange is a 6-sided shape having a flange outer surface, a flange inner surface, a front side surface, a back side surface, and two lateral side surfaces.

10. The non-welded bung system of claim 9, wherein:
a. The lateral side surfaces are aligned radially with the curvature of the flange outer surface.

11. The non-welded bung system of claim 1, wherein:
a. The threaded bung aperture is configured with a ⅜″-18 NPT thread.

12. The non-welded bung system of claim 1, wherein:
a. The threaded flange holes are configured with M6 threads.

13. The non-welded bung system of claim 1, wherein:
a. The curved outer surface substantially conforms to the shape of an inside wall of a pipe, the pipe having a diameter dimension selected from the group consisting of 2-inch, 2.5-inch 3-inch, 3.25-inch, 3.5-inch, 4-inch, 4.5-inch, 5-inch, 6-inch, 8-inch, 10-inch, 12-inch, 14-inch, and 16-inch.

14. The non-welded bung system of claim 1, further comprising:
a. A gasket; the gasket placed between the flange outer surface and the pipe inside wall.

15. The non-welded bung system of claim 1, further comprising:
a. Silicon; the silicon applied between the flange outer surface and the pipe inside wall.

16. The non-welded bung system of claim 1, wherein:
a. The flange is made from a material selected from the group consisting of aluminum, stainless steel, mild steel, titanium, high temp alloys, brass, beryllium, copper, and plastic.

17. A non-welded bung system, comprising:
a. A flange; the flange having two opposing sides, a flange outer surface and a flange inner surface; the flange outer surface forming a curved outer surface which substantially conforms to the shape of an inside wall of a pipe, the flange further comprising a plurality of flange side surfaces which span the distance between the flange inner surface and the flange outer surface, the flange having two or more flange holes disposed between the flange inner surface and the flange outer surface, the flange having a bung aperture between the flange outer surface and the flange inner surface, the bung aperture having a section of threads to form a threaded bung hole,
b. Two or more fasteners; the fasteners being rivets adapted to be installed in the flange holes.
